(19) United States
(12) Patent Application Publication
(10) Pub. No.: US 2005/0113746 A1
(43) Pub. Date: May 26, 2005

(54) System for orally administering active substances, vitamins and/or foodstuffs

(76) Inventor: Rasoul Sedaghat Kerdar, Aachen (DE)

Correspondence Address: Geza C. Ziegler, Jr.;PERMAN & GREEN, LLP, 425 Post Road, Fairfield, CT, 06824, US

(21) Appl. No.: 10/951,211

(22) Filed: Sep. 27, 2004

Related U.S. Application Data
(63) Continuation of application No. PCT/EP03/03134, filed on Mar. 26, 2003.

(30) Foreign Application Priority Data
Mar. 27, 2002 (DE) DE 102 13 773.0
Jun. 24, 2002 (DE) DE 102 28 173.4

(51) Int. Cl. A61J 7/00

(52) U.S. Cl. 604/77; D07/300.2; 215/388

(57) ABSTRACT

The invention relates to a system for orally administering active substances, vitamins and/or foodstuffs. The system includes a one-piece drinking straw with a bend or bending means, a blocking device and an active substance, vitamin and/or foodstuff formulation, which can be transported in an unimpeded manner to a drinking straw opening. The invention also relates to a kit consisting of the system and a transport liquid.

The invention relates to a system for oral administration of active substances, vitamins and/or foodstuffs comprising a one-part drinking straw with two legs and with a curvature and/or means of curvature and an active substance, vitamin and/or foodstuff formulation which can be freely conveyed by a conveying liquid to a drinking straw opening, and to a kit comprising the system and a conveying liquid.

The administration of active substances, vitamins and/or foodstuffs with the aid of a drinking straw containing an active substance, vitamin and/or foodstuff formulation which can be transported by sucking up a conveying liquid, is known. Patients who have difficulty in, or an aversion to, taking capsules or tablets are offered a further method of administering active substances, vitamins and/or foodstuffs hereby.

According to the prior art, this administration with the aid of a drinking straw is only recommended for solid formulations insoluble in the conveying liquid, while soluble formulations or soluble active substances, vitamins and/or foodstuffs are conventionally taken as a pre-produced solution in a physiologically safe liquid. However, this administering of solutions can cause problems when apportioning the active substances, vitamins and/or foodstuffs.

The systems described in the prior art for orally administering active substances, vitamins and/or foodstuffs comprise straight drinking straws, if these are in one part. However, the use of a straight drinking straw presents difficulties to a patient in the reclining or semi-reclining position.

Drinking straws are sometimes also used in the systems described in the prior art which have to be assembled from individual components prior to their use. The production and handling of these drinking straws is consequently complicated and expensive.

It is therefore the object to provide a system for orally administering active substances, vitamins and/or foodstuffs in the form of a formulation soluble or insoluble in a conveying liquid, with the aid of a drinking straw, which does not have the drawbacks of the prior art, i.e. can be easily handled by a patient even in the reclining or semi-reclining position, the system, in particular the drinking straw, also being optimally easy to produce.

According to the invention, the object is achieved by the provision of a system for oral administration of active substances, vitamins and/or foodstuffs comprising a one-part drinking straw (1) having two legs (2, 3) which are permanently connected to each other by a curvature and/or a means of curvature (4) and which each have an opening (5, 6), a blocking device impermeable for an active substance, vitamin and/or foodstuff formulation but permeable for a conveying liquid, and the active substance, vitamin and/or foodstuff formulation being arranged in one and the same leg.

The blocking device is arranged between the curvature or the means of curvature and the formulation and the formulation is arranged between the blocking device and the opening of the leg in which the blocking device and formulation are located. The blocking device preferably directly adjoins the curved region of the drinking straw.

Curvature is taken to mean any deviation from a linear orientation of the drinking straw. A curvature according to the invention is preferably a kink or bend in the wall of the drinking straw. This curvature is rigid and cannot be changed.

However, the drinking straw used according to the invention can also comprise a means of curvature which allows any desired reversibly adjustable curvature of the drinking straw, the respectively selected curvature preferably being maintained during oral administration. Such a means of curvature is for example a joint. The means of curvature most particularly preferably have a concertina-like structure. The curvature or the means of curvature are, according to the invention, also jointly called the curved region.

The drinking straw is preferably constructed from a synthetic material. At least the means of curvature is preferably constructed from a flexible, synthetic material, more preferably from a synthetic material which can be plastically deformed below its softening point.

The internal diameter of the drinking straw should be at least 3 mm, so an adequate quantity of conveying liquid can be sucked through the drinking straw to convey the formulation. The internal diameter is preferably 3 to 20 mm, more preferably 4 to 15 mm, most preferably 5 to 10 mm.

The drinking straw preferably has a round, oval, rectangular or square cross-section, more preferably a circular cross-section. The drinking straw preferably has a smooth inner side.

The active substance, vitamin and/or foodstuff formulation is preferably solid or in the form of a paste at the storage temperature of the system according to the invention, preferably at 25° C. A multi-particulate active substance, vitamin and/or foodstuff formulation is preferred, the formulation more preferably existing in the form of particles, preferably solid particles.

The active substances, vitamins and/or foodstuffs alone or the active substance, vitamin and/or foodstuff formulations as a whole can be soluble or insoluble in the conveying liquid.

If the active substances, vitamins or foodstuffs or the formulations thereof as a whole are soluble in the conveying liquid they are dissolved by the conveying liquid flowing past and are entrained in the dissolved form. If the active substances, vitamins or foodstuffs or the formulations thereof as a whole are insoluble in the conveying liquid, on the other hand, they are onwardly conveyed by the conveying liquid flowing past. Multi-particulate formulations are preferably used for this purpose. In this case, the particles should have a dimension such that they can be easily conveyed by sucking up the conveying liquid from the drinking straw. Adhesion of the particles to each other or to the drinking straw walls should be ruled out, and this can optionally be achieved by a suitable surface treatment of the particles.

The particles preferably have a diameter in the region of 100 to 1,500 μm.

All substances which can be administered orally, provided a suitable formulation is possible for the system according to the invention, can be used as the active substances, preferably therapeutic active substances, vitamins or foodstuffs. The system preferably contains a precisely determined dose of these substances.

The blocking device is preferably a stopper permeable for the conveying liquid and which is loosely attached to the walls of the drinking straw and can be moved by sucking up the conveying liquid. The stopper should be movable between the curved region and a drinking straw opening.

The dimensions of the stopper are adapted to the dimension of the drinking straw, the stopper diameter being adapted to the internal diameter of the drinking straw with a round drinking straw. The stopper is cylindrical, moreover. The drinking straw preferably comprises, at least at the opening toward which the stopper can be moved, a constriction which is configured in such a way that the stopper is kept back but the formulation particles insoluble in a conveying liquid can pass.

The stopper preferably consists of filter material, more preferably of non-woven material or press-compacted fibrous material. The stopper is comparable to a cigarette filter.

A stopper rigidly fixed in the drinking straw and permeable for the conveying liquid, a membrane fixed in the drinking straw and permeable for the conveying liquid or a grid fixed in the drinking straw, of which the mesh diameter is smaller than the smallest diameter of a multi-particulate active substance, vitamin and/or foodstuff formulation, can also be used as the blocking device.

The cross-section of membrane, grid or stopper is adapted to the cross-section of the drinking straw. The membrane is preferably glued into the drinking straw. The stopper or the grid is preferably fixed in the drinking straw by constrictions therein or is glued into the drinking straw. With the stopper, a constriction of the drinking straw on the side of the stopper remote from the curved region can be sufficient for fixing, while with the grid, constrictions on both sides are necessary.

Membrane and grid preferably consist of synthetic material. The stopper preferably consists of filter material, particularly preferably of non-woven material or press-compacted fibrous material.

Even just a constriction of the drinking straw is suitable as the blocking device, whereby the drinking straw is narrower at this point than the smallest diameter of a multi-particulate active substance, vitamin and/or foodstuff formulation. In this case, the flow of conveying liquid cannot be reduced by the blocking device to the extent that a solid, insoluble active substance, vitamin and/or foodstuff formulation can no longer be entrained.

The opening of the drinking straw, facing the active substance, vitamin and/or foodstuff formulation, is preferably provided with a closure device. The closure device is preferably a cap, or a stopper, which is preferably removed directly before oral administration.

This drinking straw opening toward which the active substance, vitamin and/or foodstuff formulation can be freely conveyed, is preferably constructed as a mouth piece, more preferably ribbed, while the other opening can preferably be configured as a connecting piece to a conveying liquid reservoir. The drinking straw preferably has a marking to indicate the mouthpiece and/or to indicate the suction direction of the conveying liquid. Handling is facilitated by this indication.

At least the part of the drinking straw containing the formulation should be transparent and/or coloured. When using a transparent drinking straw the take-up of active substance, vitamin and/or foodstuff formulation can be observed, while the use of an opaquely coloured drinking straw provides the possibility of concealing the administration of an active substance, vitamin and/or foodstuff formulation.

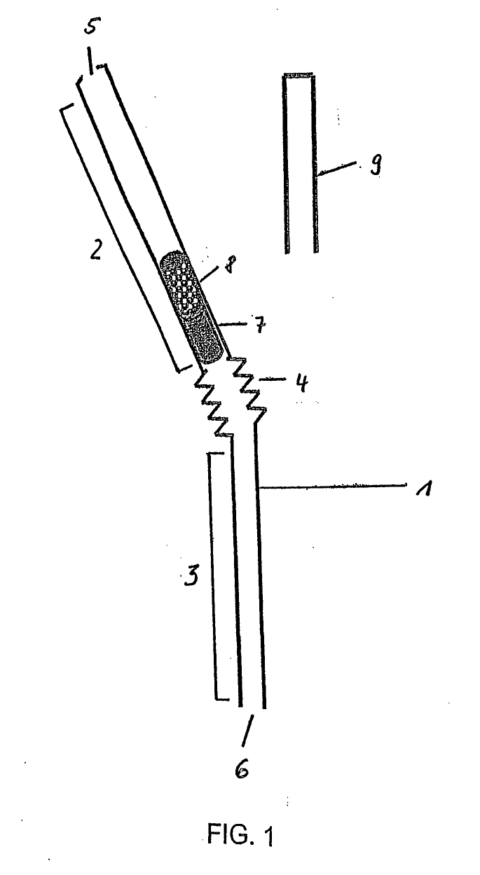

FIG. 1 shows a system according to the invention. The system comprises a drinking straw (1) with two legs (2, 3) which are connected by a means of curvature (4) and each have an opening (5, 6), the one opening (5) being constricted, a blocking device (7) located in the drinking straw and constructed as a stopper, and a formulation (8) located in the drinking straw, and a removed covering cap (9).

The drinking straw (1) has a circular cross-section. It is constructed from a flexible, synthetic material which can be plastically deformed below its softening point. The means of curvature (4) consists of a concertina-like part of the drinking straw.

The blocking device (7) is constructed from filter material and is permeable for a conveying liquid and impermeable for the formulation (8). It consists of a cylindrical stopper with a circular cross-section and a diameter corresponding to the internal diameter of the drinking straw. The stopper loosely adheres to the walls of the drinking straw and can be moved by sucking the conveying liquid through the opening (6). The stopper is located on the side of the curved region (4) at which the constricted opening (5) of the drinking straw is also located. The stopper can therefore be moved between the curved region and this constricted opening.

The formulation (8) exists in the form of spherical particles. It is located on the side of the blocking device (7) remote from the curved region (4). The particle diameter of the formulation (8) insoluble in the conveying liquid is smaller than the diameter of the constricted drinking straw opening (5), so the particles of the formulation can be freely transported through the conveying liquid out of the constricted opening and can thus be administered.

At the opening (5) facing the formulation, the drinking straw (1) is closed with the aid of covering cap (9) before use. The internal diameter of the covering cap is adapted to the external diameter of the drinking straw (1) so the covering cap can be placed on the opening.

The invention also relates to a kit comprising the system according to the invention and a physiologically safe, optionally active substance-containing conveying liquid. An aqueous liquid is preferably used as the conveying liquid, more preferably water, lemonade, fruit juice without fruit pulp, tea or coffee.

1. System for oral administration of active substances, vitamins and/or foodstuffs, comprising a one-part drinking straw (1) having two legs (2, 3) which are permanently connected to each other via a curvature and/or a means of curvature (4) and which each comprise an opening (5, 6), wherein a blocking device impermeable for an active substance, vitamin and/or foodstuff formulation but permeable for a conveying liquid is arranged in one and the same leg and the active substance, vitamin and/or foodstuff formulation are arranged in such a way
that the blocking device is located between the curvature or the means of curvature and the active substance, vitamin and/or foodstuff formulation, and
that the active substance, vitamin and/or foodstuff formulation is located between the blocking device and an opening.

2. System according to claim 1, characterised in that the active substance, vitamin and/or foodstuff formulation is solid.

3. System according to claim 1, characterised in that the active substance, vitamin and/or foodstuff formulation is in the form of a paste.

4. System according to claim 1, characterised in that the active substance, vitamin and/or foodstuff formulation is multi-particulate, and is preferably present in the form of particles.

5. System according to any one of claims 1 to 4, characterised in that the active substance, vitamin and/or foodstuff formulation is insoluble in the conveying liquid.

6. System according to any one of claims 1 to 4, characterised in that at least the active substance, the vitamin and/or the foodstuff of the formulation is soluble in the conveying liquid.

7. System according to any one of claims 1 to 6, characterised in that the blocking device is a stopper which loosely adheres to the walls of the drinking straw and can be moved by sucking up the conveying liquid.

8. System according to claim 7, characterised in that the stopper can be moved between the curved region and an opening.

9. System according to claim 8, characterised in that, at least in the opening toward which the stopper can be moved, the drinking straw is constricted to a smaller cross-section than that of the stopper.

10. System according to any one of claims 7 to 9, characterised in that the stopper consists of filter material.

11. System according to any one of claims 1 to 6, characterised in that the blocking device is a stopper fixed in the drinking straw.

12. System according to any one of claims 1 to 6, characterised in that the blocking device is a membrane fixed in the drinking straw.

13. System according to any one of claims 1 to 6, characterised in that the blocking device is a grid fixed in the drinking straw, of which the mesh diameter is smaller than the smallest diameter of the formulation particles.

14. System according to any one of claims 1 to 6, characterised in that the blocking device consists of a constriction of the drinking straw, so the cross-section of the drinking straw is narrower than the smallest diameter of the formulation particles.

15. System according to any one of claims 1 to 14, characterised in that the drinking straw consists of a synthetic material.

16. System according to any one of claims 1 to 14, characterised in that at least the means of curvature is constructed from a flexible, synthetic material.

17. System according to any one of claims 1 to 16, characterised in that at least the means of curvature is constructed from a synthetic material which can be plastically deformed below its softening point.

18. System according to any one of claims 1 to 14, characterised in that the means of curvature is configured as a concertina.

19. System according to any one of claims 1 to 18, characterised in that the internal diameter of the drinking straw is at least 3 mm.

20. System according to any one of claims 1 to 19, characterised in that the opening facing the active substance, vitamin and/or foodstuff formulation is provided with a closure device.

21. System according to claim 20, characterised in that the closure device is a cap (9) or stopper.

22. System according to any one of claims 1 to 21, characterised in that the opening, to which the active substance, vitamin and/or foodstuff formulation can be freely conveyed, is constructed as a mouthpiece, and is preferably ribbed.

23. System according to any one of claims 1 to 22, characterised in that the other opening is constructed as a connecting piece to a reservoir of the conveying liquid.

24. System according to any one of claims 1 to 23, characterised in that the drinking straw comprises a marking for identifying the mouthpiece and/or for indicating the suction direction of the conveying liquid.

25. System according to any one of claims 1 to 24, characterised in that at least the part of the drinking straw containing the formulation is transparent and/or coloured.

26. Kit consisting of the system according to any one of claims 1 to 25 and a physiologically safe, optionally active substance-containing conveying liquid.

27. Kit according to claim 26, characterised in that the conveying liquid is present as an aqueous liquid.

28. Kit according to either claim 26 or claim 27, characterised in that the conveying liquid is water, lemonade, fruit juice without fruit pulp, tea or coffee.
